(19) United States
(12) Patent Application Publication
(10) Pub. No.: US 2026/0107081 A1
(43) Pub. Date: Apr. 16, 2026

(54) WEARABLE AUDIO DEVICE AND REMOVABLE COVER PLATE

(71) Applicant: BOSE CORPORATION, Framingham, MA (US)

(72) Inventors: Allen T. GRAFF, Sutton, MA (US); Paul C. WILLIAMSON, Worcester, MA (US)

(21) Appl. No.: 18/912,953

(22) Filed: Oct. 11, 2024

(51) Int. Cl. H04R 1/10

(52) U.S. Cl. CPC H04R 1/105

(57) ABSTRACT

A wearable audio device comprising a body and a cover plate. The body is configured to be located in or on an ear of the user. The body includes an acoustic module and a body latching feature. The acoustic module is located such that the acoustic module is configured to be located in or on the ear of the user. The cover plate is removably coupled to an outer surface of the body by the body latching feature.

### BACKGROUND

The present disclosure generally relates to a modular wearable audio device and a removable cover plate therefore. Wearable audio devices typically emit sound at a location close to, in, around, or on a user's ear.

### SUMMARY

All examples and features mentioned below can be combined in any technically possible way.

Aspects of the present disclosure provide a wearable audio device. The wearable audio device includes a body and a cover plate is provided. The body is configured to be worn in or on an ear of the user. The body includes an acoustic module and a body latching feature. The acoustic module is located such that the acoustic module is configured to be located in or on the ear of the user. The cover plate is removably coupled to an outer surface of the body by the body latching feature.

In aspects, the cover plate includes a cover plate latching feature and the cover plate latching feature interacts with the body latching feature to removably couple the cover plate to the body.

In aspects, the body latching feature includes at least one tab and the cover plate latching feature includes at least one recess and the at least one tab is engagable with the at least one recess to removably couple the cover plate to the outer surface of the body.

In aspects, the at least one recess includes a slot and the tab is slidably engagable with the slot.

In aspects, the slot at least partially defines an overhang and the cover plate is engagable with a surface of the overhang to removably couple the cover plate to the outer surface of the body.

In aspects, the body latching feature includes a magnet.

In aspects, the cover plate is magnetic and the cover plate is removably coupled to the body by an interaction between the cover plate and the magnet.

In aspects, the cover plate includes a cover plate magnet and an interaction between the cover plate magnet and the magnet of the body removably couples the cover plate to the body.

In aspects, the body includes a recess, the body latching feature is disposed in the recess, and the cover plate is removably disposed in the recess.

Aspects of the present disclosure provide a wearable audio device. The wearable audio device including a body. The body includes an acoustic module and a body latching feature. The acoustic module is configured to transmit audio and is located such that the body and the acoustic module are configured to be worn in or on an ear of a user. The body latching feature is configured to interact with a cover plate to removably couple the cover plate to an outer surface of the body.

In aspects, the body latching feature includes one or more tabs.

In aspects, the body latching feature includes a magnet.

In aspects, the body latching feature is configured to slidably engage with the cover plate to removably couple the cover plate to the outer surface of the body.

In aspects, the body latching feature is configured to interact with the cover plate to removably couple the cover plate to the outer surface of the body thereby at least partially covering the outer surface.

In aspects, the body includes a recess and the body latching feature is disposed in the recess such that the body latching feature is configured to removably dispose the cover plate in the recess.

In aspects, the body further includes a feedback feature configured to indicate when the cover plate is removably coupled to the outer surface of the body.

In aspects, the body further includes a first portion and a second portion, wherein the second portion is perpendicular to the first portion and the body latching feature is configured to interact with the cover plate to removably couple the cover plate to the body thereby at least partially covering the first portion and at least partially covering the second portion.

Aspects of the present disclosure provide a cover plate that is configured to be removably coupled to a body of a wearable audio device such that the cover plate at least partially defines an outer surface of the body when coupled to the body. The cover plate includes a cover plate body and a cover plate latching feature. The cover plate latching feature is configured to removably couple the cover plate to the body of the wearable audio device.

In aspects, the cover plate latching feature includes at least one slot.

In aspects, the cover plate latching feature includes at least one magnet Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 illustrates an exemplary wearable audio device, according to one or more aspects.

FIG. 2 illustrates the exemplary wearable audio device of FIG. 1 on an ear of a user, according to one or more aspects.

FIG. 3A illustrates an exemplary wearable audio device with the cover plate removed from the body, according to one or more aspects.

FIG. 3B illustrates a detailed view of a portion of the body including the recess of the exemplary wearable audio device of FIG. 3A, according to one or more aspects.

FIG. 3C illustrates a detailed view of a portion of the cover plate of the exemplary wearable audio device of FIG. 3A, according to one or more aspects.

FIG. 4A illustrates a detailed view of the cover plate of the exemplary wearable audio device of FIGS. 3A-3C uninstalled from the body of the exemplary wearable audio device, according to one or more aspects.

FIG. 4B illustrates a detailed view of the cover plate of the exemplary wearable audio device of FIGS. 3A-3C partially installed to the body of the exemplary wearable audio device, according to one or more aspects.

FIG. 4C illustrates a detailed view of the cover plate of the exemplary wearable audio device of FIGS. 3A-3C fully installed to the body of the exemplary wearable audio device, according to one or more aspects.

FIG. 5 illustrates another exemplary wearable audio device, according to one or more aspects.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In aspects, the disclosure contemplates that terms such as “couples,” “coupling,” “couple,” and “coupled” may include but are not limited to, interference fitting, magnetic fastening, interlocking coupling, adhesively coupling, pinned coupling. In aspects, the disclosure contemplates that terms such as “couples,” “coupling,” “couple,” and “coupled” may include but are not limited to integrally forming. In aspects, the disclosure contemplates that terms such as “couples,” “coupling,” “couple,” and “coupled” may include but are not limited to direct coupling and/or indirect coupling, such as indirect coupling through intermediate components.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the headphones herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Aspects of the present disclosure provide systems, apparatus, and methods regarding a wearable audio device having a removable, customizable cover plate. The wearable audio device includes a body and a removable cover plate. The cover plate is secured in a recess in the body by the interaction between a body latching feature and a cover plate latching feature.

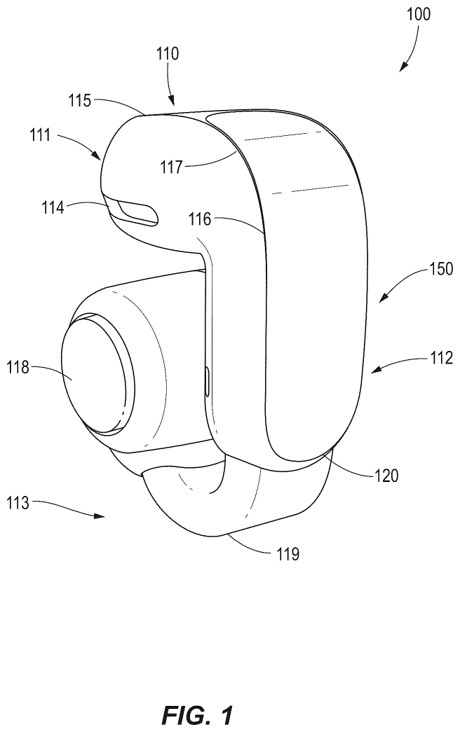

FIG. 1 illustrates an exemplary wearable audio device 100. Wearable audio device 100 includes a body 110 and a cover plate 150. The cover plate 150 may be removably coupled to the body 110 such that the cover plate 150 at least partially defines the outer surface of the body 110.

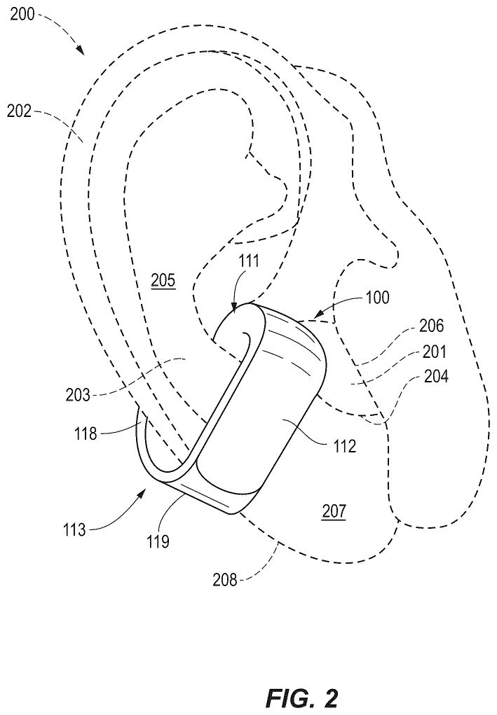

The body 110 includes an acoustic module 111, a first portion 112, and a second portion 113. The body 110 and its components include one or more inner cavities, which may be interconnected or discrete, for housing electronics necessary for the operation of the wearable audio device (e.g. one or more acoustic transducers, strain gauges, flexible circuitry, a printed circuit board (PCB), and a power source). Any of the acoustic module 111, first portion 112, and second portion 113 may be separate from one another and coupled to one another, or may be integral to one another. The body 110 is sized and shaped such that the acoustic module 111 may emit sound near, in, or on a user's ear. In the presently illustrated embodiment, the body 110 is generally “C” shaped, wherein the acoustic module 111 extends from (e.g. perpendicular to) the first portion 112 of the body 110 and the second portion 113 extends from (e.g. perpendicular to) the first portion 112 in generally the same direction as the acoustic module 111 so as to form a cuff around a wearer's the anti-helix 203 as shown in FIG. 2.

The acoustic module 111 is configured to sit in a portion of the user's ear (e.g. in the cavum conchae of the user's ear). The acoustic module 111 includes at least one sound-emitting opening 114 that emits sound produced by an acoustic transducer disposed in a cavity inside of the acoustic module 111. When the wearable audio device 100 is disposed on a user's ear, the sound emitting opening 114 is configured to be spaced apart from, in, or proximate the user's ear canal. The acoustic module 111 includes an outer surface 115. In one or more embodiments, the acoustic module 111 may further include a compliant or compressible member (not shown) on all or part of the acoustic module 111 for compliance and comfort with the outer ear of a user.

The first portion 112 is configured to pass over the outer ear (e.g. at least one of the anti-helix 203 and the helix 202 and lobule 207 of the ear) of the user. The first portion 112 includes an outer surface 116. The outer surface 116 may be at least partially flat and connects to the outer surface 115 of the acoustic module 111 by, for example, a curved surface 117. In one or more embodiments, the outer surface 116 of the first portion 112, the curved surface 117, and the outer surface 115 of the acoustic module 111 define a continuous surface. The first portion 112 further includes an inner cavity and is configured to house electronics necessary for the operation of the wearable audio device 100.

The second portion 113 includes a distal portion 118 and a connecting portion 119. The connecting portion 119 extends from the first portion 112 and the distal portion 118 is coupled to the end of the connecting portion 119. The distal portion 118 is configured to be located behind the outer ear of a user between the outer ear of the user and the head of a user (as shown in FIG. 2 and further described with respect to FIG. 2).

The distal portion 118 is shaped to house and/or hold a power source. In one or more embodiments, the power source is a battery power source (e.g. a rechargeable power source). In one or more embodiments, the distal portion 118 may be generally cylindrical such that the distal portion 118 is shaped to hold a cylindrical power source. The connecting portion 119 may include a cavity configured to house necessary electronics for the operation of the wearable audio device 100.

In one or more embodiments, any combination of the acoustic module 111, the first portion 112, and the second portion 113 are integral. For example, any combination of the acoustic module 111, the first portion 112, and the second portion 113 may be parts of a unitary molded plastic housing that is constructed and arranged to house the aforementioned electronics.

In one or more embodiments, any combination of the outer surfaces of the acoustic module 111, the first portion 112, the connecting portion 119, and the distal portion 118 are continuous. In the illustrated embodiment, the outer surfaces and the inner surfaces of the acoustic module 111 and the first portion 112 are continuous.

The body 110 further includes a recess 120 disposed in the outer surface of the body 110. The recess 120 is configured to removably contain the cover plate 150.

FIG. 2 illustrates the exemplary wearable audio device 100 of FIG. 1 on a user's ear 200.

Generally, the outer ear (also known as the auricle or pinna) of a human includes a concha that is immediately adjacent to the entrance to the ear canal, which is underneath (or, behind) the tragus. The concha is divided by the helix crus into a lower portion termed the cavum conchae and an upper portion termed the cymba conchae. The cavum conchae is a generally bowl-shaped feature that is directly adjacent to the ear canal. The cavum conchae typically includes a depression bordered by the anti-tragus, which is the lower part of the anti-helix and/or bordered by the lobule. The lobule (i.e., the earlobe), which is at the lower end of the helix, is typically just below the anti-tragus.

In FIG. 2, the user's ear 200 is illustrated as including the cavum conchae 201, the helix 202, the anti-helix 203, the anti-tragus 204, the concha 205, the tragus 206, and the lobule 207. The concha 205 includes the cavum conchae 201 with the anti-tragus 204 forming the lower border of the cavum conchae 201.

The body 110 of the wearable audio device 100 is configured to pass over the user's ear 200 such that the acoustic module 111 sits in the cavum conchae 201, the first portion 112 passes over the outer edge 208 of the ear 200 (e.g. at least one of the helix 202, the anti-helix 203, and the lobule 207), the connection portion 119 wraps around the outer edge 208 of the ear 200, and the distal portion 118 sits behind the ear 200 (e.g. between the backside of the ear 200 and the head of the user).

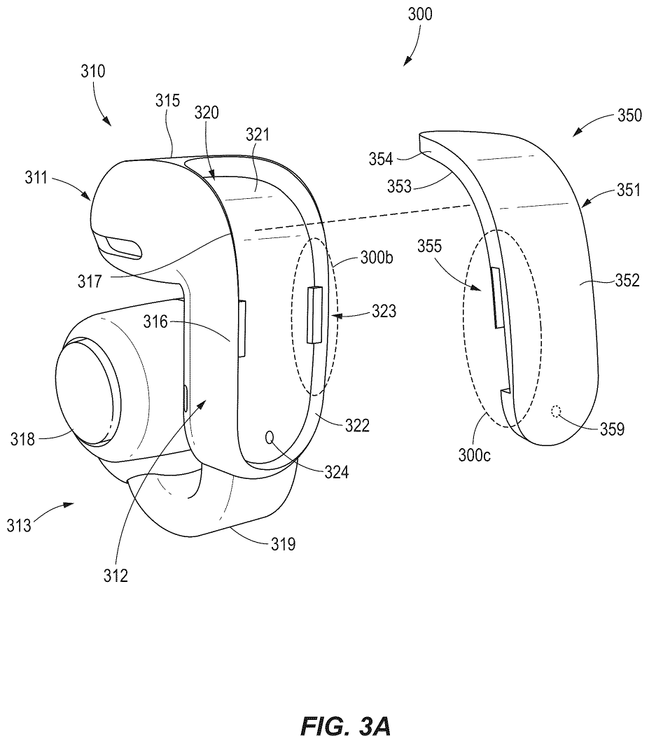

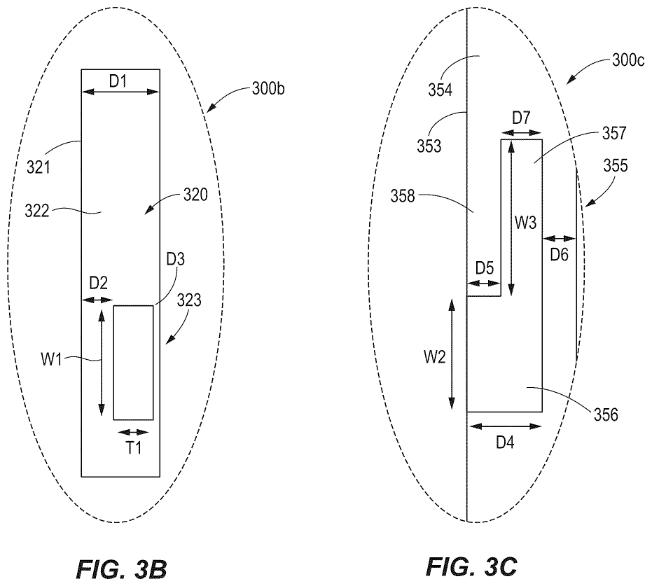

FIGS. 3A-3C illustrate an exemplary audio device 300 with the cover plate 350 removed. FIG. 3A illustrates the exemplary audio device 300 including the body 310 and the cover plate 350. The cover plate 350 is removably attachable to the body 310 as shown by the dotted line. FIG. 3B is a detailed view of area 300b including a portion of the body 310 including the recess 320. FIG. 3C is a detailed view of area 300c including a portion of the cover plate 350. For brevity, all components of the exemplary wearable audio device 300 that are similar to components of the wearable audio device 100 have been given reference numbers with the same last two digits, and a full description of such similar components are not repeated.

The recess 320 may be completely or partially disposed in any combination of the outer surface 315 of the acoustic module 311, the connection surface 317, the outer surface 316 of the first portion 312, the outer surface of the connecting portion 319, and the outer surface of the distal end 318. In the illustrated embodiment, the recess 320 is partially disposed in the outer surface 315 of the acoustic module 311, the connection surface 317, and the outer surface 316 of the first portion 312.

The recess 320 includes a base surface 321. The base surface 321 of the recess 320 may be coplanar with the outer surface(s) of the body 310 in which the recess 320 is disposed. The base surface 321 is a depth D1 from the outer surface(s) of the body 110 in which the recess 320 is disposed. The depth D1 may be about 0.7 millimeters (mm) to about 1.5 mm. In one or more embodiments, D1 may be about 0.8 mm. The recess 320 further includes an inner surface 322 which circumscribes the recess 320.

The recess 320 further includes a body latching feature 323 configured to removably couple the cover plate 350 to the body 310 and into the recess 320. In one or more embodiments, the body latching feature 323 may comprise one or more tabs. The one or more tabs 323 may protrude from the inner surface 322 of the recess 320 into the recess 320. In one or more embodiments, the one or more tabs 323 may include one tab 323 extending across the recess 320 between opposite ends of the inner surface 322. In the illustrated embodiment, the one or more tabs 323 includes two discrete tabs, each extending from opposite ends of the inner surface 322 of the recess 120. The one or more tabs 323 may be spaced apart from the base surface 321 of the recess 320 by a distance D2 and may be spaced apart from the outer surface of the body 110 by a distance D3. The distance D2 may be about 0.3 mm to about 1.2 mm. In one or more embodiments, D2 may be about 0.4 mm. The distance D3 may be about 0.0 mm to about 0.9 mm. In one or more embodiments, D3 may be about 0.0 mm. That is, there may be a gap between the one or more tabs 323 and the base surface 321 of the recess 320 and a gap between the one or more tabs 323 and the outer surface of the body 110.

The tab 323 includes a width W1 and a thickness T1. The width W1 may be about 2.0 mm to about 10 mm. In one or more embodiments, W1 may be about 3.0 mm. The thickness T1 may be about 0.3 mm to about 1.0 mm. In one or more embodiments, T1 is about 0.4 mm.

The recess may include a feedback feature 324, such as a detent, disposed in the inner surface 322 or the base surface 321 of the recess 320, configured to give feedback to the user when the cover plate 150 is fully assembled into the recess 320.

The cover plate 350 includes a body 351. The body includes an outer surface 352, an inner surface 353, a side surface 354, and one or more cover plate latching features 355. In one or more embodiments, the body 351 further includes a feedback feature 359 complementary to the feedback feature 324 of the body 310 to provide feedback to the user when the cover plate 350 is fully installed.

The cover plate 350 conforms to the shape of the recess 320 of the body 310 and the outer surface of the body 310 in which the recess 320 is disposed so that the outer surface 352 of the cover plate 350 at least partially defines a continuous outer surface of the body 310 when installed in the recess 320. In one or more embodiments, the outer surface 352 of the cover plate 350 is at least partially flush, if not completely flush, with the outer surface of the body 310 when installed. In one or more embodiments, the outer surface 352 of the cover plate 350 protrudes from the outer surface of the body 310 when installed.

The cover plate latching feature 355 may be one or more slots 355 disposed in the side surface 354 of the cover plate 350. In one or more embodiments, the one or slots 355 is a singular slot extending from one side of the cover plate 350 to the other with a continuous shape correlating to the embodiment wherein the body latching feature 323 is a singular tab 323 extending across the recess 320. In one or more embodiments, such as the one illustrated, the one or more slots 355 is two discrete slots 355 disposed in the side surface 354 of the cover plate 350 on either side of the cover plate corresponding to the embodiment wherein the body latching feature 323 is two discrete tabs 323 protruding from the inner surface 322 of the recess 320.

The one or more slots 355 include a first portion 356 and a second portion 357. The first potion 356 extends through the inner surface 353 of the cover plate 350. The second portion 357 extends from the first portion 356 at an angle, such as 90°. Thus, the first portion 356 and the second portion 357 make an “L” shape, with the first portion 356 being disposed through the inner surface 353 of the cover plate 350 and the second portion 357 being isolated from the inner surface 353 and the outer surface 352. The first portion 356 and the second portion 357 create an overhang 358. The overhang 358 is disposed between the second portion 357 and the inner surface 353 of the cover plate 350. In other words, the overhang 358 fills the empty portion of the “L”-shaped slot 355.

The first portion 356 has a width of W2 and a depth of D4. The width W2 may be about 2.0 mm to about 10.0 mm. In one or more embodiments, W2 is about 3.25 mm. The depth D4 may be about 0.6 mm to about 1.5 mm. In one or more embodiments, D4 is about 0.8 mm. The width W2 corresponds to the width W1 of the one or more tabs 323 so that the one or more tabs 323 may slide into the first portion 356. The depth D4 corresponds to the depth of the recess D1, the thickness of the cover plate 350, and the thickness T1 of the one or more tabs 323. Accordingly, the corresponding dimensions of the one or more tabs 323 and the first portion 356 of the slot 355 such that the cover plate 350 may be disposed in the recess 320, the one or more tabs 323 may be slid into the first portion 356 such that the inner surface 353 of the cover plate 350 abuts the base surface 321 of the recess 320 when the one or more tabs 323 abuts the end of the first portion 356 of the slot 355 and the one or more tabs 323 is aligned with the intersection of the first portion 356 of the slot 355 and the second portion 357 of the slot 355.

The second portion 357 has a width Depth D7 and a width W3. The depth D7 may be about 0.3 mm to about 1.0 mm. In one or more embodiments, D7 may be about 0.45 mm. The width W3 may be about 1.0 mm to about 12.0 mm. In one or more embodiments, W3 is about 3.25 mm. In one or more embodiments, W3 is equal to W2. The depth D7 corresponds to the thickness T1 of the tabs 323. The width W3 corresponds to the size and shape of the cover plate 350 and the size and shape of the recess 320 such that when the tab 323 is slid to the end of the second portion 357, the cover plate 350 is fully seated/installed in the recess 320 (such as shown in FIG. 1).

The second portion 357 is separated from the inner surface 353 of the cover plate 350 by a distance D5 and is separated from the outer surface 352 of the cover plate 350 by a distance D6. Distance D5 may be about 0.3 mm to about 1.2 mm. In one or more embodiments D5 is about 0.35 mm. Distance D6 may be about 0.3 mm to about 2.0 mm. In one or more embodiments, D6 may be about 0.6 mm. Accordingly, the second portion 357 is disposed in the side surface 354 of the cover plate 350 and does not pass through the inner surface 353 of the cover plate 350 or the outer surface 352 of the cover plate 350.

The distance D5 also defines the thickness of the overhang 358. The overhang 358 prevents the tab 323 from escaping the slot 355 other than by passing through the first portion 356.

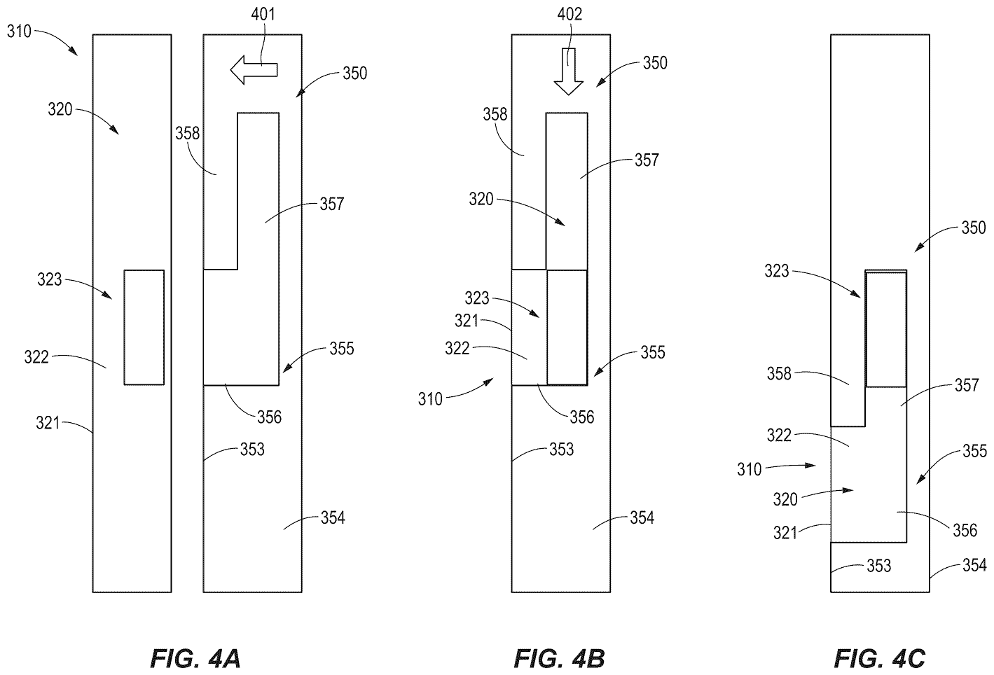

FIGS. 4A-4C illustrates detailed views of the cover plate 350 being assembled onto the body 310. FIG. 4A illustrates the cover plate 150 uninstalled from the body 310. FIG. 4B illustrates the cover plate 350 partially installed to the body 310. FIG. 4C illustrates the cover plate 150 fully installed to the body 310.

According to one mode of operation, the first portion 356 of the slot 355 of the cover plate 350 is aligned with the one or more tabs 323 of the body 310, as shown in FIG. 4A. The cover plate 350 is moved in the direction of arrow 401 until the one or more tabs 323 abuts the end of the first portion 356 of the slot 355, as shown in FIG. 4B. In one or more embodiments, when the one or more tabs 323 abuts with the end of the first portion 356 of the slot 355, the inner surface 353 of the cover plate 350 abuts the base surface 321 of the recess 320. In one or more embodiments, the inner surface 353 of the cover plate 350 does not abut the base surface 321 of the recess 320. In one or more embodiments, when the one or more tabs 323 abuts the end of the first portion 356 of the slot 355, the outer surface 352 of the cover plate 350 is flush with the outer surface of the body 310 in which the recess 320 is disposed. In one or more embodiments, the outer surface 352 of the cover plate 350 is not flush with the outer surface of the body 310 in which the recess 320 is disposed.

When the one or more tabs 323 abuts the end of the first portion 356 of the slot 355, the cover plate 350 is moved in the direction of arrow 402 to slide the second portion 357 of the one or more slots 355 along the one or more tabs 323. When the one or more tabs 323 reaches the end of the second portion 357 of the one or more slots 355, the cover plate 350 is fully installed, as shown in FIG. 4C. In one or more embodiments, wherein the cover plate 350 includes the feedback feature 359 and the body 310 includes the feedback feature 324, the interactions of the feedback features give feedback to the user indicating that the cover plate 350 is fully installed in the body 310.

When the one or more tabs 323 reaches the end of the second portion 357 of the one or more slots 355, the cover plate 350 is prevented from moving in any direction other than the direction opposite arrow 402. For example, the cover plate 350 is prevented from moving in the direction opposite of arrow 401 by the overhang 358. Uninstalling cover plate 350 requires reversing the operations listed above for installation.

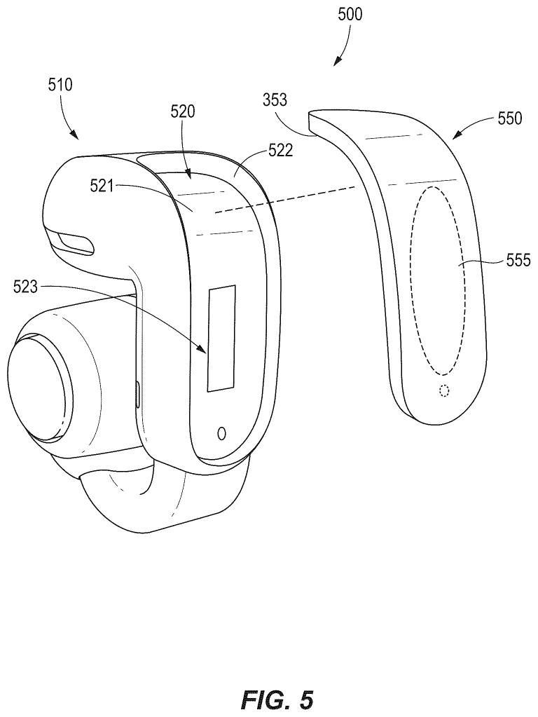

FIG. 5 illustrates another exemplary wearable audio device 500 wherein a cover plate 550 is removably coupled to a body 510 of the wearable audio device 500 by magnetism. For brevity, all components of the exemplary wearable audio device 500 that are similar to components of the wearable audio devices 100, 300 have been given reference numbers with the same last two digits, and a full description of such similar components are not repeated herein.

In one or more embodiments, the body latching feature 523 may include one or more magnets 523. The one or more magnets 523 are configured to magnetically couple the cover plate 550 to the body 510 in the recess 520. The one or more magnets 523 may be disposed in or on the base surface 521 of the recess.

Similarly, the cover plate latching feature 555 may be one or more magnets 555. The one or more magnets 555 of the cover plate 550 may be disposed in or on the inner surface 353 of the cover plate 550. The magnets 555 of the cover plate 550 are configured to be attracted to the one or more magnets 523 of the body 510 so that the cover plate 550 may be installed in the recess 520 of the body 510. In one or more embodiments, the cover plate 550 does not include magnets 555 and is instead made of a magnetic material, such as a metal. In such embodiments, the magnets 523 of the body 510 attract the cover plate 550 rather than magnets in the cover plate 550. Similarly, in one or more embodiments, the body 510 does not include magnets 523 and is instead made of a magnetic material, such as metal. In such embodiments, the magnets 555 of the cover plate 550 are attracted to the body 510 rather than magnets in the body 510.

Any one or more components of the wearable audio devices 100, 300, 500 may be integrally formed together, directly coupled together, and/or indirectly coupled together and are not limited to the specific arrangement of components illustrated in FIGS. 1-5. Any one or more of the components or embodiments of the wearable audio devices 100, 300, 500 may be combined in whole or part with any other components or embodiments of the wearable audio devices 100, 300, 500.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A wearable audio device, comprising:
a body configured to be located in or on an ear of a user, the body comprising:
an acoustic module, the acoustic module located such that the acoustic module is configured to be located in or on the ear of the user; and
a body latching feature; and
a cover plate, wherein the cover plate is removably coupled to an outer surface of the body by the body latching feature.

2. The wearable audio device of claim 1, wherein the cover plate includes a cover plate latching feature, and wherein the cover plate latching feature interacts with the body latching feature to removably couple the cover plate to the body.

3. The wearable audio device of claim 2, wherein the body latching feature comprises at least one tab and the cover plate latching feature comprises at least one recess, and wherein the at least one tab is engagable with the at least one recess to removably couple the cover plate to the outer surface of the body.

4. The wearable audio device of claim 3, wherein the at least one recess comprises a slot and the tab is slidably engagable with the slot.

5. The wearable audio device of claim 4, wherein the slot at least partially defines an overhang and wherein the cover plate is engagable with a surface of the overhang to removably couple the cover plate to the outer surface of the body.

6. The wearable audio device of claim 1, wherein the body latching feature comprises a magnet.

7. The wearable audio device of claim 6, wherein the cover plate is magnetic, and wherein the cover plate is removably coupled to the body by an interaction between the cover plate and the magnet.

8. The wearable audio device of claim 6, wherein the cover plate includes a cover plate magnet, and wherein an interaction between the cover plate magnet and the magnet of the body removably couples the cover plate to the body.

9. The wearable audio device of claim 1, wherein the body includes a recess, wherein the body latching feature is disposed in the recess, and wherein the cover plate is removably disposed in the recess.

10. A wearable audio device, comprising:
a body, the body comprising:
an acoustic module configured to transmit audio, the acoustic module located such that the body and the acoustic module are configured to be located in or on an ear of a user; and
a body latching feature, wherein the body latching feature is configured to interact with a cover plate to removably couple the cover plate to an outer surface of the body.

11. The wearable audio device of claim 10, wherein the body latching feature comprises one or more tabs.

12. The wearable audio device of claim 10, wherein the body latching feature comprises a magnet.

13. The wearable audio device of claim 10, wherein the body latching feature is configured to slidably engage with the cover plate to removably couple the cover plate to the outer surface of the body.

14. The wearable audio device of claim 10, wherein the body latching feature is configured to interact with the cover plate to removably couple the cover plate to the outer surface of the body thereby at least partially covering the outer surface.

15. The wearable audio device of claim 10, wherein the body includes a recess and the body latching feature is disposed in the recess such that the body latching feature is configured to removably dispose the cover plate in the recess.

16. The wearable audio device of claim 10, wherein the body further comprises a feedback feature configured to indicate when the cover plate is removably coupled to the outer surface of the body.

17. The wearable audio device of claim 10, the body further comprising a first portion and a second portion, wherein the second portion is perpendicular to the first portion and the body latching feature is configured to interact with the cover plate to removably couple the cover plate to the body thereby at least partially covering the first portion and at least partially covering the second portion.

18. A cover plate that is configured to be removably coupled to a body of a wearable audio device such that the cover plate at least partially defines an outer surface of the body when coupled to the body, the cover plate comprising:
a cover plate body; and
a cover plate latching feature configured to removably couple the cover plate to the body of the wearable audio device.

19. The cover plate of claim 18, wherein the cover plate latching feature comprises at least one slot.

20. The cover plate of claim 18, wherein the cover plate latching feature comprises at least one magnet.
